(19) United States
(12) Patent Application Publication
(10) Pub. No.: US 2015/0297442 A1
(43) Pub. Date: Oct. 22, 2015

(54) MASSAGE DEVICE

(71) Applicant: FUN FACTORY GMBH, Bremen (DE)

(72) Inventor: Dirk BAUER, Bremen (DE)

(21) Appl. No.: 14/435,146

(22) PCT Filed: Oct. 10, 2013
(86) PCT No.: PCT/DE2013/000586

§ 371 Date: Apr. 10, 2015

(30) Foreign Application Priority Data
Oct. 10, 2012 (DE) 10 2012 019 842.6

(51) Int. Cl. A61H 15/00

(52) U.S. Cl. CPC A61H 15/0078

(57) ABSTRACT

The invention relates to a massage device (1) with at least one rubber-elastically deformable wall (2), and with at least one actuator (3), which is arranged and configured for the purpose of acting on a sub-region of the elastically deformable wall (2), thus deforming same. It is characterized in that the actuator (3) is formed with an electroactive polymer, and in that the actuator (3) is electrically connected to a control unit (4) arranged in or directly on the massage device (1) and can be actuated by means of this control unit (4).

### FIELD OF THE INVENTION

The invention relates to a massage device with at least one rubber-elastically deformable wall, with at least one actuator, which is arranged and configured for the purpose of acting on a sub-region of the elastically deformable wall, thus deforming same, and to uses of such a massage device.

### PRIOR ART AND BACKGROUND OF THE INVENTION

A massage device of the aforementioned design is known from practice. In these devices, on a driven shaft of an electromotive drive, a deformation element rotating with the driven shaft is arranged as actuator, wherein the deformation element has at least one projection or a protruding roller which circulating from inside in the rubber-elastic outer wall presses against this and outwardly deforms the outer wall in the area of the deformation element. The massage function is ultimately provided by the consequently circulating deformation of the rubber-elastic outer wall.

A disadvantage of this prior art is that, in order to generate the massage effect, a continuous force application of the electromotive drive is necessary. Moreover, as a result of the circulating deformation element, disturbing frictional forces between the deformation element and the rubber-elastic outer casing continuously have to be overcome. There are therefore relatively high losses of mechanical energy. Overall, therefore, a relatively high consumption of electrical energy by the electromotive drive, which is a particular problem if the massage device is powered by battery or accumulator with the electrical energy. The battery or accumulator either have to be relatively large for reasons of capacitance, and therefore heavy, or the operator has to accept a relatively short running time. A further disadvantage is that, because of the structure, the massage pattern of the finished device is unalterable. Only the frequency of the actuations of the actuators can be controlled and/or regulated via the speed of rotation of the electromotive drive. Finally, even in smoothly running electromotive drives, noises occur that may disturb a person using the massage device, and mechanical wear, caused by only occasional lubrication of mechanical structural elements running against each other, limits the useful life of the massage device.

Actuators with electromotive polymers are known from other technical fields. In this connection, reference is made, solely by way of example, to the literature source U.S. Pat. No. 6,249,076 B1.

### TECHNICAL PROBLEM ADDRESSED BY THE INVENTION

The technical problem addressed by the invention is therefore that of making available a massage device which is freely controllable in terms of the massage pattern, which has reduced noise development, whose energy consumption is reduced, and which is almost free of mechanical wear.

### ESSENTIAL FEATURES OF THE INVENTION AND PREFERRED EMBODIMENTS

To solve this technical problem, the invention teaches that the actuator is formed with or from an electroactive polymer, and the actuator is electrically connected to a control unit arranged in or directly on the massage device and can be actuated by means of this control unit.

By the use of an actuator with an electroactive polymer, a massage device is permitted which is practically free of rigid mechanical components moving against each other. To this extent, frictional losses do not occur. Likewise, noise development caused by mechanics is excluded. Finally, while the mechanical excursion of the rubber-elastic wall is the same, the energy consumption is reduced, such that the control unit can comprise smaller batteries or accumulators and the running time until discharge is lengthened.

An actuator with an electroactive polymer typically contains, in addition to the polymer itself, at least one electrode and a counter-electrode. At least one of these electrodes is expediently rubber-elastic itself, although this in most cases applies to both electrodes. When an electrical voltage is applied to electrode and counter-electrode, an electroactive polymer or actuator can expand in at least one direction from a rest state or contract, depending on the polarity of the voltage.

The rubber-elastic wall can be pretensioned against the actuator, or it may not. In the former case, a greater mechanical excursion of the rubber-elastic wall can take place if the actuator is controlled with alternating polarity, because then the wall goes along with the contraction of the actuator. If the wall is rigidly connected to the actuator, then such pretensioning is of course dispensable.

The actuator can in principle be formed from an ionic, electrostrictive, piezoelectric or dielectric polymer. Electrostrictive, piezoelectric and dielectric polymer actuators have the polymer itself and, on opposite sides of the polymer part, electrode parts (electrode and counter-electrode) and have the advantage of very low power consumption and formation exclusively from solids. For actuation, however, relatively high voltages are needed, which sometimes lie in the range of the breakdown voltage of the polymer layer. Moreover, for a high mechanical excursion, a stacking of a plurality of actuators is necessary in most cases, similarly to the inorganic piezoelectric actuators. Ionic polymer actuators typically have an active polymer part with electrode part, a counter-electrode part, and an electrolyte part, which is arranged between the active polymer part and the counter-electrode part and they have the advantage of high mechanical excursions at only low voltages, typically less than a volt (0.1 to 5 V, for example 1 to 2 V). A disadvantage is that, depending on the construction, one component is liquid or gel-like and, to this extent, a diffusion-tight casing is needed for components of the electrolyte, unless such a diffusion-tight enclosure is already provided anyway by the components of the device that surround the actuator. In particular on account of the electromechanical advantages, ionic electroactive polymer actuators are particularly preferred.

Electroactive polymers in ionic polymer actuators are typically synthetic organic polymers which are conductive for electrical current and which, when subjected to electrical energy, undergo a shape change, expansion or contraction in at least one spatial direction. Such polymers typically have a conjugated backbone and have the property of increasing the electrical conductivity under oxidation or reduction. Examples of electroactive polymers include polyaniline, polysulfone, polypyrrole and polyacetylene. These materials, in pure form, are semiconductors, but the electrical conductivity is increased under reduction or oxidation. This oxidation or reduction leads to a charge transfer, which in turn results in ion transport into the material for compensation thereof. These ions (or dopands) enter the polymer from an ionically conductive electrolyte medium, which is connected directly to the polymer. The electrolyte can be a liquid, a gel, but also a solid. If ions are already present in the polymer material through reduction or oxidation, they can of course leave for the purpose of charge transfer. The insertion (or the departure) of ions between the chains of the polymer can then lead to the expansion (or contraction) in a direction perpendicular to the extent of the chains. In other polymers, it is not the insertion of ions between chains that plays the main role, but a modifiable repulsion of the chains relative to one another. In any case, the stream of ions into or out of the polymer material leads to the expansion or contraction thereof.

Linear and volumetric changes of dimension of up to 30% and more are presently possible by means of ionic electroactive polymer actuators. The attainable mechanical stress in the dimension change is of the order of magnitude of several MPa. The latter means that these actuators are of interest specifically for massage devices, since this mechanical stress corresponds to that of smooth muscle cells.

The massage device can in principle be of any desired type, purpose and shape.

A particular variant of a for example substantially rod-shaped massage device is characterized in that a plurality of actuators are arranged in the rubber-elastic wall or are connected thereto, in that the massage device has at least one substantially cylindrical sub-region, and in that at least two actuators in the cylindrical sub-region are arranged lying opposite each other, as viewed in the cross section orthogonal to a cylinder axis, wherein the actuators lying opposite each other can be controlled to modify their expansion in the axial direction of the cylindrical sub-region, specifically in a manner independent of each other, in particular in push-pull mode or in common mode, wherein, by means of the independent control of the actuators lying opposite each other, bending movements and/or axial expansion movements of the cylindrical sub-region of the massage device can be generated. In this embodiment, the rubber-elastic wall is connected to each actuator at at least two places, specifically at places of the actuator that move relative to each other under electrical control. In the case of the actuators being embedded in the rubber-elastic wall, the actuators are preferably oriented substantially coaxially with respect to their expansion/contraction.

In this variant, the massage device can be operated in such a way that actuators lying opposite each other can be controlled in common mode, in push-pull mode or with a predefined constant or variable phase difference, as a result of which axial expansion movements and/or bending movements of the massage device or of cylindrical sub-regions of the massage device are generated. The expression bending movement refers here to a projection of the movement into a plane comprising the cylinder axis. To this extent, bending movements in several such planes at an angle to each other are possible, which then result, for example, in orbiting movements (in a plane orthogonal to the cylinder axis of the massage device or of a sub-region thereof) of a part of the massage device relative to another part at an axial distance. Instead of the orbit, any other desired trajectories are of course also possible, for example elliptic, and can easily be programmed into the control.

In another variant, the massage device can have an inner wall, which forms a hollow space provided with an insertion opening, and which is designed as the rubber-elastically deformable wall. A body part, for example a foot, a finger or a penis, is then introduced through the insertion opening into the hollow space and is massaged by the movements of the rubber-elastic wall on which the body part bears. However, it is also possible that the rubber-elastically deformable wall is an outer wall of the massage device. Then, the massage device can be held with its rubber-elastic wall on a body part or can be introduced into a body cavity and can there exert the massage effect.

Generally, in a group of embodiments, the one or more actuators act on the rubber-elastic wall substantially perpendicularly with respect to the surface of the wall. In the context of the invention, however, it is also possible that the actuators act on the wall in the direction of extent of the surface of the wall. The latter means that the massage device as a whole can deform, for example in the case of a substantially cylindrical massage device with an outer rubber-elastic wall, in such a way that sub-regions of the massage device can bend out from the cylinder axis, for example an end of the massage device can be controlled rotating to and fro or all the way round the cylinder axis, as is explained in detail above.

Typically, a plurality of actuators are provided in a massage device according to the invention, wherein the actuators act on different sub-regions of the rubber-elastically deformable wall, either perpendicularly with respect to the surface thereof or substantially in directions of the surface. With such a plurality, practically all conceivable massage patterns can be generated constructively. In the simplest case, the actuators are either electrically parallel or anti-parallel and/or in series and are connected to the control unit and act the same way. In this embodiment, it is possible to work with a very simple control unit, and only a few supply lines (in most cases 2) to the electrodes are needed. By contrast, it is advantageous in terms of variability if the actuators are each individually electrically connected to the control unit and/or are controllable independently of each other by means of the control unit. A practically free programmability of the massage pattern and of the time profile thereof is achieved in this way. In these connections, it is also possible that the actuators are distributed across the surface of the rubber-elastic wall uniformly, regularly or irregularly.

Specifically, the construction will generally be such that the one or more actuators are arranged to the inside of the rubber-elastic wall and are supported against a support element on the side of the actuators opposite the rubber-elastic wall, which support element has a modulus of elasticity greater than the modulus of elasticity of the rubber-elastic wall, for example by at least 10%, in particular by at least 100%. In other words, the actuator supports itself against a comparatively stiff abutment. In addition to the modulus of elasticity of the abutment, however, its expansion space also plays a role, because the compressibility of solids, including those with an extremely low modulus of elasticity, is practically zero. The material of the abutment or its modulus of elasticity is irrelevant if the construction of the massage device as a whole is such that the abutment cannot (appreciably) change its position.

The control unit comprises, in addition to control electronics, also an energy store for electrical energy, for example a battery or an accumulator. The control unit usually also has an operating unit, with which an operator can switch the massage device on and off and can preselect or adjust a desired massage pattern, massage frequency, massage direction, etc. The control unit can be integrated in the massage device but can also be separate from it, for example provided as a wireless remote control. Likewise, (wireless) control via the Internet is also possible. In the case of accumulators, connections to the mains network (with integrated charging electronics) or to separate charging electronics can also be provided, again either wired or wireless, for example inductive.

The invention finally also relates to the use of such a massage device for the personal hygiene and/or sexual stimulation of a person operating it. For this purpose, the person operating it places the massage device on the body part to be massaged, introduces a body part to be massaged into the massage device or introduces the massage device into a body cavity to be massaged. Before, during or after this, the massage device is activated by the operator or by another.

The invention is explained in more detail below on the basis of examples that merely represent illustrative embodiments. In the drawing:

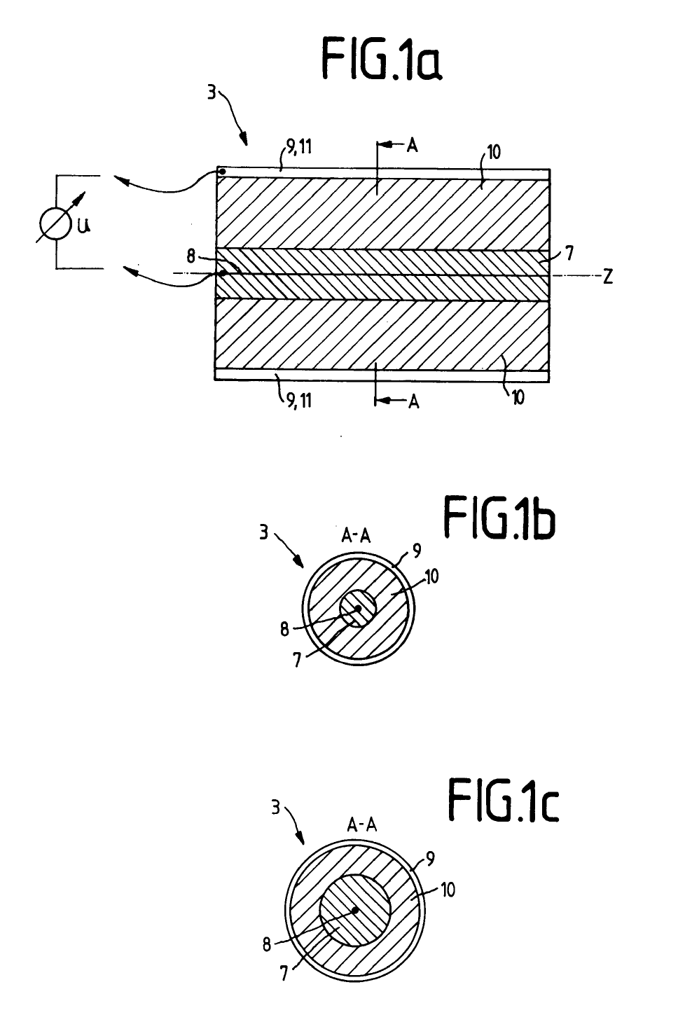

FIG. 1 shows a schematic diagram of an ionic electroactive polymer actuator, in longitudinal section through the axis Z (a), and in cross section in the current-free state (b) and current-applied state (c),

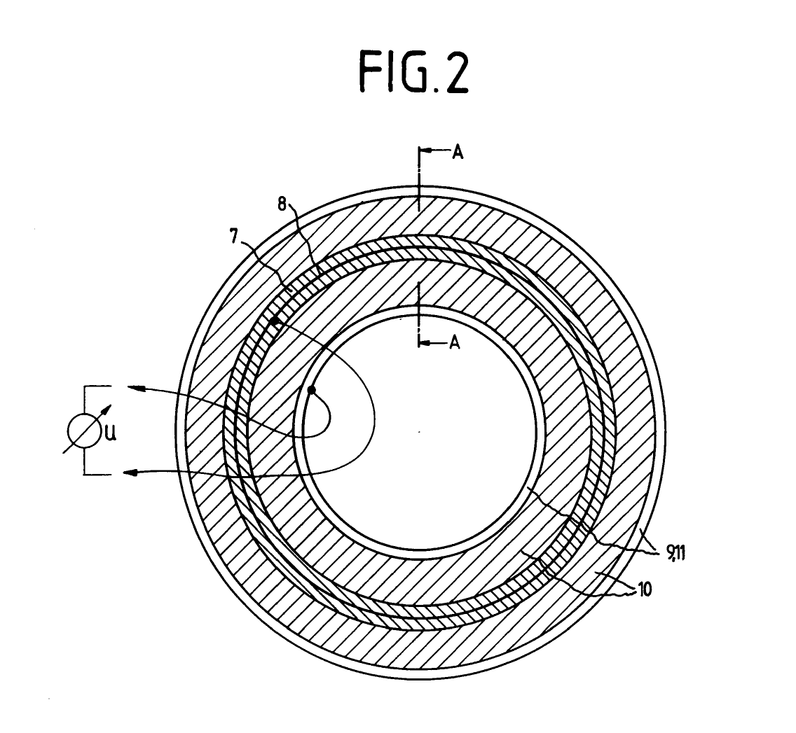

FIG. 2 shows a ring-shaped actuator, analogous to the subject matter of FIG. 1, that can be used in the context of the invention,

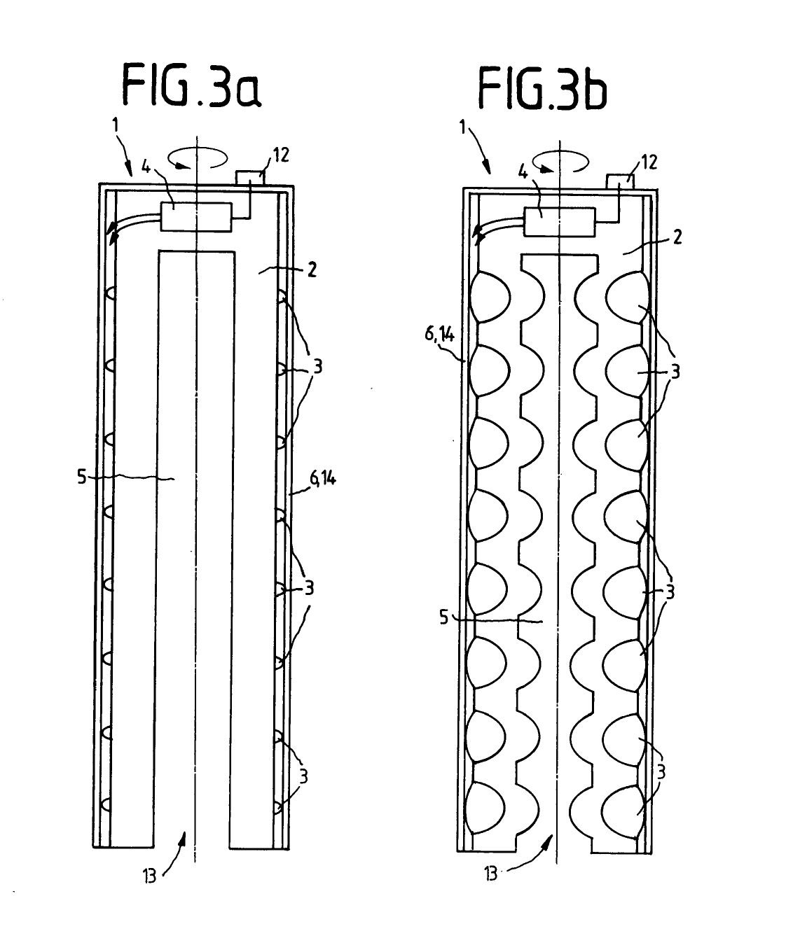

FIG. 3 shows a first embodiment of a massage device actuators (a), and with current-applied actuators (b),

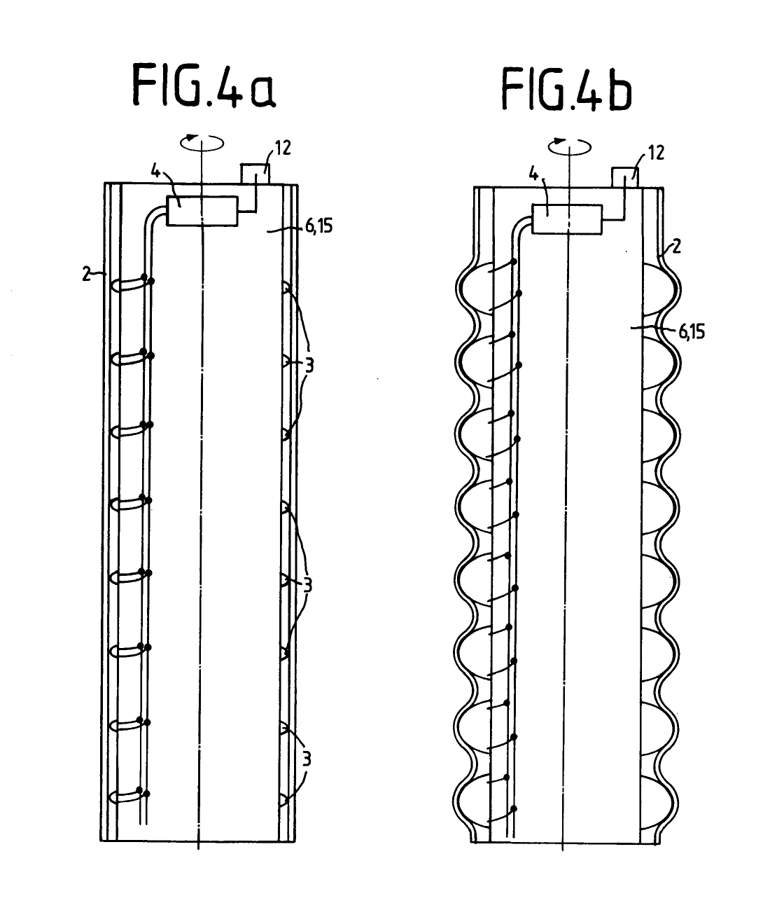

FIG. 4 shows a second embodiment of a massage device according to the invention, with current-free actuators (a), and with current-applied actuators (b),

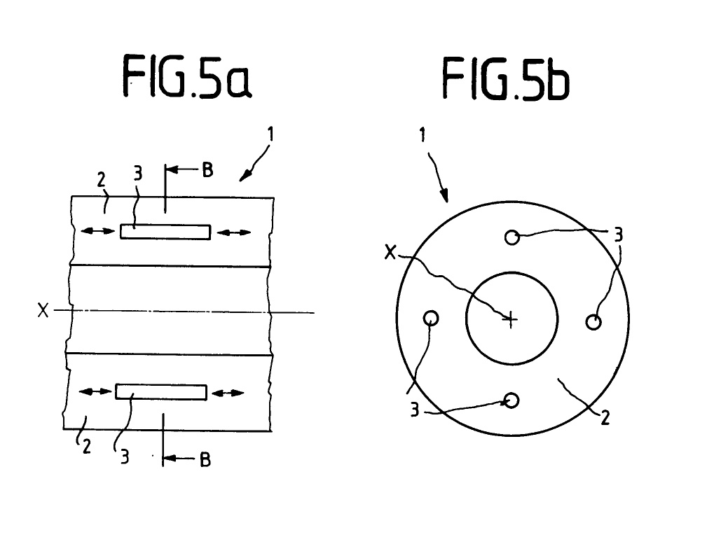

FIG. 5 shows a third embodiment of a massage device according to the invention, in partial view in longitudinal cross section (a), and in transverse section of the plane B-B (b),

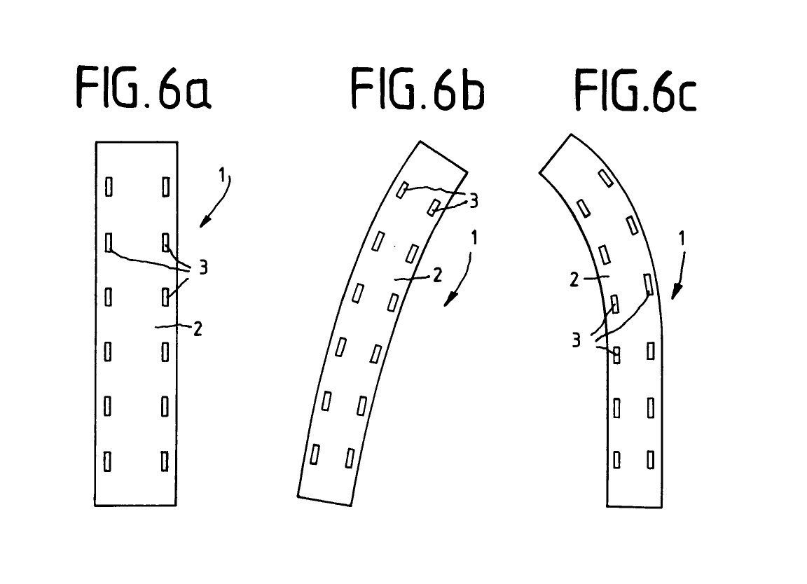

FIG. 6 shows an overall view of a massage device according to FIG. 5 in different operating positions.

FIG. 1a shows an actuator 3 used according to the invention, with an active polymer part 7 with electrode 8, with a counter-electrode part 9, and with an electrolyte part 10, which is arranged between the active polymer part 7 and the counter-electrode part 9. In the active polymer part 7, the polymer chains are oriented substantially parallel to the axis Z. This can be achieved by means of methods known in polymer technology, for example stretching. The polymer part 7 consists, for example, of a polyaniline, polysulfone, polypyrrole or polyacetylene polymer. For example, a suitable polypyrrole polymer can be produced by means of electrodeposition using the method described in M. Yamaura, Synthetic Metals, vol. 36, pages 209-224, 1988. The polymer part 7 can be configured as a film, fiber or bundle of fibers. If the electrolyte part 10 is formed from a solid, it should be formed from elastic material and, in addition, should not delaminate from the polymer part 7 upon actuation of the actuator 3. If the electrolyte part 10 is formed from a gel, it is possible, for example, to use agar or polymethyl methacrylate with a salt as dopand. In the case of a liquid, a possible example is a phosphate buffer solution. Preferably, the electrolyte part 10 is formed from non-toxic substances for the unlikely event of a leak. The electrode 8 can be formed from any desired electrically conductive material, whether a conductive polymer gel, an(other) electrically conductive solid polymer material or a metal, for example gold, platinum or stainless steel. The counter-electrode part 9 is expediently formed from a solid, electrically conductive (other) polymer material that has the required elasticity to elastically take up the expansion of the polymer part 7 when current is applied. If this polymer material is also diffusion-tight with respect to the components of the electrolyte part 10, the counter-electrode part serves at the same time as casing 11.

FIGS. 1b and 1c show a cross section in the plane A-A, on the one hand with no current applied (b) and on the other hand with current applied (c). It will be seen from a comparison of these that, when current is applied, the polymer part 7 expands in the radial direction, relative to the views of FIGS. 1b and 1c, as a result of which the external diameter of the actuator 3 is in turn increased.

In the context of the further illustrative embodiments, FIG. 2 shows a variant of an actuator 3. Here, the two ends of the actuator of FIG. 1a are in principle connected to each other, as a result of which a ring-shaped actuator 3 is formed. The cross-sectional drawings of FIGS. 1a and 1b and the explanation of these drawings also apply here by analogy.

FIGS. 3 and 4 show a massage device 1 according to the invention, with a rubber-elastically deformable wall 2 and with a plurality of actuators 3 arranged and configured for the purpose of acting on a sub-region of the elastically deformable wall 2, thus deforming same. The actuator 3 is formed with an electroactive polymer and is connected electrically to a control unit 4 arranged in the massage device 1 and can be actuated by means of this control unit 4. The figure also shows an operating unit 12 connected to the control unit 4.

In the embodiment in FIG. 3, the massage device 1 has an inner wall 2, which forms a hollow space 5 provided with an insertion opening 13, and which forms the rubber-elastically deformable wall 2. A relatively stiff outer wall 14 forms a support element or abutment for the actuators 3, such that, upon actuation of the actuators 3, the rubber-elastic inner wall is pressed inward at those places where it bears on the actuators 3.

In the embodiment in FIG. 4, by contrast, the rubber-elastically deformable wall 2 forms an outer wall 2 of the massage device 1. Here, a core 15 functions as support element 6 or abutment for the actuators 3, such that, upon actuation of the actuators, the rubber-elastic outer wall 2 is pressed outward in those areas where it bears on the actuators 3.

In the examples in FIGS. 3 and 4, the actuators are electrically connected in parallel and are connected to the control unit 4 and thus act identically. It will be appreciated that, alternatively, the actuators 3 can each individually be electrically connected to the control unit 4 and/or can be controlled independently of one another by means of the control unit 4. Likewise, the actuators 3, instead of being provided regularly as shown, can also be provided irregularly. Finally, the massage device 1 can in principle also deviate from the cylinder shape shown and have any other desired shape. It will be appreciated that it is also possible for intermediate layers (not shown), for example of polymer materials, to be arranged between the components shown.

The mode of operation of the two embodiments in FIGS. 3 and 4 is evident from a comparison of respective figure parts a and b. In the example in FIG. 3, a massage effect is exerted on the body part introduced into the insertion opening 13, by means of the actuators being alternately fed with current by the control unit 4 and being without current. In the example in FIG. 4, the massage effect takes place in a corresponding way, except that the massage device 1 is in this case held on a body part or inserted into a body cavity.

FIG. 5 shows a further embodiment (as per claim 2) of a massage device according to the invention in different cross sections. It will be noted that a plurality of actuators are implanted in a rubber-elastic wall 2. The actuators 3 can of course also be mounted on the outer side or inner side of the wall. When current is applied, the ends of the actuators move in the direction of the arrows, thereby expanding. When the current is switched off, contraction takes place again in the direction of the arrows all the way to the rest state. A hollow space can be formed inside the wall 2 analogously to FIG. 3, although it is also possible to provide a core made of the same or different rubber-elastic material, foam, gel, liquid or other deformable materials. The actuators 3 can be controlled individually by the control device 4 (not shown). By the distribution of a plurality of actuators, 2, in particular at least 3, up to 100 and more in one segment according to FIGS. 5a and 5b, the segment can bend in any directions from the axis X, for example by means of actuators 3 lying opposite each other being supplied differently with current. A massage device 1 according to the invention can be formed from a multiplicity of segments according to FIG. 5, thus giving an embodiment according to FIG. 6. The latter shows various deformations in schematic form, wherein the correlated expansion states of different actuators 3 are shown with exaggerated expansion in order to make matters clearer.

Of course, the embodiments in FIGS. 5 and 6 can be combined with those in FIGS. 3 and 4. This provides an extremely flexible and universal variability of a massage pattern which can also be freely chosen by an operator and adjusted according to the individual preferences.

1-12. (canceled)

13. A massage device
with at least one rubber-elastically deformable wall, with at least one actuator, which is arranged and configured for the purpose of acting on a sub-region of the elastically deformable wall, thus deforming same, and
with a control unit arranged in or directly on the massage device,
characterized in that
the actuator is formed with an electroactive polymer, and
the actuator is electrically connected to the control unit and can be actuated by means of this control unit.

14. The massage device as claimed in claim 13, characterized in that massage device is substantially rod-shaped, wherein the rubber-elastically deformable wall comprises at least one substantially cylindrical sub-region, and wherein the actuator being embedded in the rubber-elastic wall.

15. The massage device as claimed in claim 13, characterized in that
a plurality of actuators are arranged in the rubber-elastic wall or connected thereto, the massage device has at least one substantially cylindrical sub-region,
at least two actuators in the cylindrical sub-region are arranged lying opposite each other, as viewed in the cross section orthogonal to a cylinder axis,
wherein the actuators lying opposite each other can be controlled to modify their expansion in the axial direction of the cylindrical sub-region, specifically in a manner independent of each other, in particular in push-pull mode or in common mode,
wherein, by means of the independent control of the actuators lying opposite each other, bending movements and/or axial expansion movements of the cylindrical sub-region of the massage device can be generated.

16. The massage device as claimed in claim 14, characterized in that a plurality of actuators are arranged in the rubber-elastic wall or connected thereto, the massage device has at least one substantially cylindrical sub-region,
at least two actuators in the cylindrical sub-region are arranged lying opposite each other, as viewed in the cross section orthogonal to a cylinder axis,
wherein the actuators lying opposite each other can be controlled to modify their expansion in the axial direction of the cylindrical sub-region, specifically in a manner independent of each other, in particular in push-pull mode or in common mode,
wherein, by means of the independent control of the actuators lying opposite each other, bending movements and/or axial expansion movements of the cylindrical sub-region of the massage device can be generated.

17. The massage device as claimed in claim 13, characterized in that the actuator act on the rubber-elastic wall substantially perpendicularly with respect to the surface of the wall.

18. The massage device as claimed in claim 14, characterized in that the actuator act on the rubber-elastic wall substantially perpendicularly with respect to the surface of the wall.

19. The massage device as claimed in claim 13, characterized in that the massage device has an inner wall, which forms a hollow space provided with an insertion opening for receiving a body part, and which is designed as the rubber-elastically deformable wall.

20. The massage device as claimed in one of claims 13, characterized in that the rubber-elastically deformable wall is an outer wall of the massage device.

21. The massage device as claimed in one of claims 13, characterized in that a plurality of actuators are provided, wherein the actuators act on different sub-regions of the rubber-elastically deformable wall.

22. The massage device as claimed in claim 20, characterized in that the actuators are either electrically connected in parallel or anti-parallel and/or in series and are connected to the control unit and act in common mode or in push-pull mode, or are each individually electrically connected to the control unit and/or are controllable independently of each other by means of the control unit.

23. The massage device as claimed in one of claims 13, characterized in that the one or more actuators are arranged to the inside of the rubber-elastic wall and are supported against a support element on the side of the actuators opposite the rubber-elastic wall, which support element has a modulus of elasticity greater than the modulus of elasticity of the rubber-elastic wall.

24. The massage device as claimed in one of claims 13, characterized in that the actuator is formed from an ionic, electrostrictive, piezoelectric or dielectric polymer.

25. The massage device as claimed in one of claims 15, characterized in that the actuators are distributed across the surface of the rubber-elastic wall uniformly, regularly or irregularly.

26. The massage device as claimed in one of claims 13, characterized in that an actuator has an active polymer part with electrode, a counter-electrode part, and an electrolyte part, which is arranged between the active polymer part and the counter-electrode part.

27. The massage device as claimed in claim 26, characterized in that the actuator has a diffusion-tight casing.

28. The massage device as claimed in claim 13, characterized in that the actuator provides linear and/or volumetric changes of dimension of up to 30% and more.

29. A method for operating a massage device, in particular as claimed in claim 15, wherein actuators lying opposite each other are controllable in common mode, in push-pull mode or with a predefined constant or variable phase difference, as a result of which axial expansion movements and/or bending movements of the massage device or of cylindrical sub-regions of the massage device are generated.

30. A method for operating a massage device, in particular as claimed in claim 16, wherein actuators lying opposite each other are controllable in common mode, in push-pull mode or with a predefined constant or variable phase difference, as a result of which axial expansion movements and/or bending movements of the massage device or of cylindrical sub-regions of the massage device are generated.
